(19) United States
(12) Patent Application Publication
(10) Pub. No.: US 2024/0414275 A1
(43) Pub. Date: Dec. 12, 2024

(54) IMAGE PROCESSING APPARATUS, IMAGE PROCESSING SYSTEM, AND IMAGE PROCESSING METHOD

(71) Applicant: PFU LIMITED, Kahoku-shi (JP)

(72) Inventor: Kazuhiko Tsuda, Kahoku-shi (JP)

(21) Appl. No.: 18/677,646

(22) Filed: May 29, 2024

(30) Foreign Application Priority Data
Jun. 9, 2023 (JP) 2023-095743

(51) Int. Cl. H04N 1/00; H04N 1/393; H04N 1/40; H04N 1/60

(52) U.S. Cl. CPC H04N 1/00801; H04N 1/00448; H04N 1/00824; H04N 1/393; H04N 1/40068; H04N 1/60; H04N 2201/0081

(57) ABSTRACT

An image processing apparatus includes circuitry to set first setting information regarding an input image generation process; acquire an input image in which a medium is imaged according to the first setting information; determine, based on the input image, whether the first setting information matches a feature of the input image; and identify second setting information matching the feature of the input image when determining that the first setting information does not match the feature of the input image. When processing the input image according to the second setting information is feasible, the circuitry processes the input image according to the second setting information to generate a processed image, and outputs display data for displaying the processed image on a display.

### CROSS-REFERENCE TO RELATED APPLICATIONS

This patent application is based on and claims priority pursuant to 35 U.S.C. § 119 (a) to Japanese Patent Application No. 2023-095743, filed on Jun. 9, 2023, in the Japan Patent Office, the entire disclosure of which is hereby incorporated by reference herein.

### BACKGROUND

### Technical Field

The present disclosure relates to an image processing apparatus, an image processing system, and an image processing method.

### Related Art

Currently, image processing apparatuses such as a scanner, which scans multiple media to generate images while sequentially conveying the media, have been used for imaging of various types of media in a wide variety of applications. The image quality required of such an image processing apparatus differs depending on, for example, its purpose and the type of media to be read. In general, the image processing apparatus has various setting items, such as size and color, relating to imaging processing of media or image processing to generate an appropriate image according to, for example, the application or type of media. However, if the settings are inappropriate, the image processing apparatus may fail to acquire an appropriate image.

In a known technique, when an image processing apparatus in which settings are made generates an output image based on a read image acquired from a document, the image processing apparatus determines whether the output image satisfies the requirements corresponding to the settings. The image processing apparatus provides a preview of the output image when determining that the output image does not satisfy the requirements.

### SUMMARY

In one aspect, an image processing apparatus includes circuitry to set first setting information regarding an input image generation process; acquire an input image in which a medium is imaged according to the first setting information; determine, based on the input image, whether the first setting information matches a feature of the input image; and identify second setting information matching the feature of the input image when determining that the first setting information does not match the feature of the input image. When processing the input image according to the second setting information is feasible, the circuitry processes the input image according to the second setting information to generate a processed image, and outputs display data for displaying the processed image on a display.

In another aspect, an image processing system includes an image reading apparatus and an information processing apparatus. The image processing system includes circuitry to acquire first setting information regarding an input image generation process; acquire an input image in which a medium is imaged according to the first setting information; determine, based on the input image, whether the first setting information matches a feature of the input image; and identify second setting information matching the feature of the input image when determining that the first setting information does not match the feature of the input image. When processing the input image according to the second setting information is feasible, the circuitry processes the input image according to the second setting information to generate a processed image, and display the processed image on a display.

In another aspect, an image processing method includes setting first setting information regarding an input image generation process; acquiring an input image in which a medium is imaged according to the first setting information; determining, based on the input image, whether the first setting information matches a feature of the input image; identifying second setting information matching the feature of the input image based when determining that the first setting information does not match the feature of the input image; processing the input image according to the second setting information to generate a processed image when processing the input image according to the second setting information is feasible; and outputting display data for displaying the processed image on a display.

### BRIEF DESCRIPTION OF THE DRAWINGS

A more complete appreciation of embodiments of the present disclosure and many of the attendant advantages and features thereof can be readily acquired and understood from the following detailed description with reference to the accompanying drawings, wherein:

FIG. 1 is a diagram illustrating a schematic configuration of an image processing system an embodiment of the present disclosure;

FIG. 2 is a perspective view of an image reading apparatus of the image processing system illustrated in FIG. 1;

FIG. 3 is a diagram illustrating a conveyance passage inside the image reading apparatus illustrated in FIG. 2;

FIG. 4 is a schematic block diagram illustrating a configuration of the image reading apparatus illustrated in FIG. 2;

FIG. 5 is a schematic diagram illustrating an example data structure of a setting information table;

FIG. 6 is a diagram illustrating schematic configurations of a first storage device and a first processing circuit of the image reading apparatus illustrated in FIG. 4;

FIG. 7 is a schematic block diagram illustrating a configuration of an information processing apparatus of the image processing system illustrated in FIG. 1;

FIG. 8 is a flowchart of an image reading process performed by the image reading apparatus illustrated in FIG. 6;

FIG. 9 is another flowchart of the image reading process performed by the image reading apparatus illustrated in FIG. 6;

FIG. 10 is a schematic diagram illustrating an example of display data output by the image reading apparatus illustrated in FIG. 6;

FIG. 11 is a schematic diagram illustrating another example of the display data;

FIG. 12 is a schematic diagram illustrating an example of second display data output by the image reading apparatus illustrated in FIG. 6;

FIG. 13 is a flowchart of an image reading process according to another embodiment;

FIG. 14 is a schematic diagram illustrating an example of display data in the image reading process illustrated in FIG. 13;

FIG. 15 is a block diagram illustrating a schematic configuration of a first processing circuit of an image reading apparatus according to another embodiment;

FIG. 16 is a block diagram illustrating a schematic configuration of a second storage device and a second processing circuit of an information processing apparatus according to still another embodiment; and

FIG. 17 is a block diagram illustrating a schematic configuration of a second processing circuit of an information processing apparatus according to still another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image processing apparatus, an image processing system, an image processing method, and a control program according to embodiments of the present disclosure are described below with reference to the drawings. The technical scope of the present disclosure is not limited to the embodiments described below and covers equivalents of elements described below. Thus, numerous additional modifications and variations are possible in light of the above teachings.

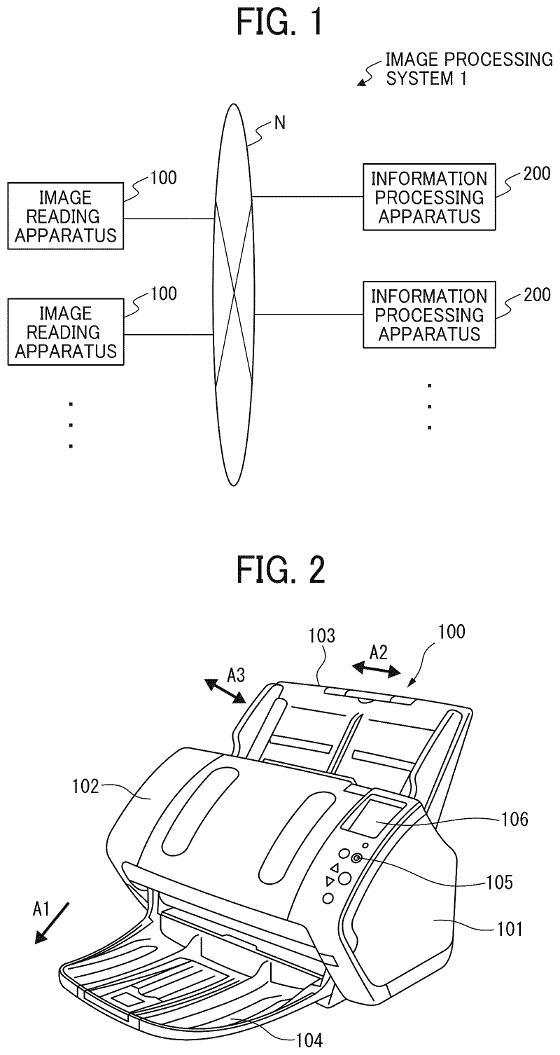

FIG. 1 is a diagram illustrating a schematic configuration of an image processing system 1 according to an embodiment.

As illustrated in FIG. 1, the image processing system 1 includes one or more image reading apparatuses 100 and one or more information processing apparatuses 200. The image reading apparatus 100 and the information processing apparatus 200 are communicatively connected to each other through a network N. The network N is, for example, the Internet or an intranet. The image reading apparatus 100 and the information processing apparatus 200 are each an example of an image processing apparatus.

The image reading apparatus 100 is, for example, an auto document feeder (ADF) type scanner that images a medium such as a document while conveying the media. The media are, for example, sheets of plain paper, sheets of thin paper, sheets of thick paper, or cards. The media include various types of media such as receipts, business cards, invoices, and delivery notes. Alternatively, the image reading apparatus 100 may be, for example, a facsimile machine, a copier, or a multifunction printer, which is also called “a multifunction peripheral (MFP).”

The information processing apparatus 200 is, for example, a personal computer, a notebook personal computer, a tablet computer, or a smartphone. The information processing apparatus 200 may be a server that resides on a cloud network.

FIG. 2 is a perspective view of the image reading apparatus 100.

The image reading apparatus 100 includes a lower housing 101, an upper housing 102, a medium tray 103, an ejection tray 104, a first input device 105, and a first display device 106.

The upper housing 102 is disposed to cover the upper face of the image reading apparatus 100, and is hinged to the lower housing 101 such that the upper housing 102 can be opened and closed, for example, to remove a jammed medium or clean the inside of the image reading apparatus 100.

The medium tray 103 is engaged with the lower housing 101 such that the media to be conveyed can be placed on the medium tray 103. The ejection tray 104 is engaged with the lower housing 101 such that the media ejected from the ejection port can be held on the ejection tray 104.

The first input device 105 includes an operation device such as buttons and an interface circuit that receives signals from the operation device. The first input device 105 receives an input operation performed by a user and outputs an operation signal corresponding to the input operation performed by the user. The first display device 106 includes a display and an interface circuit that outputs image data to the display and displays an image on the display according to the image data. Examples of the display include a liquid crystal display and an organic electro-luminescence (EL) display.

In FIG. 2, arrow A1 indicates the direction in which a medium is conveyed (also “media conveyance direction A1”), arrow A2 indicates the width direction perpendicular (also “width direction A2”) to the media conveyance direction, and arrow A3 indicates the height direction perpendicular to the media conveyance direction and the width direction. In the following, upstream is upstream in the media conveyance direction A1, and downstream is downstream in the media conveyance direction A1.

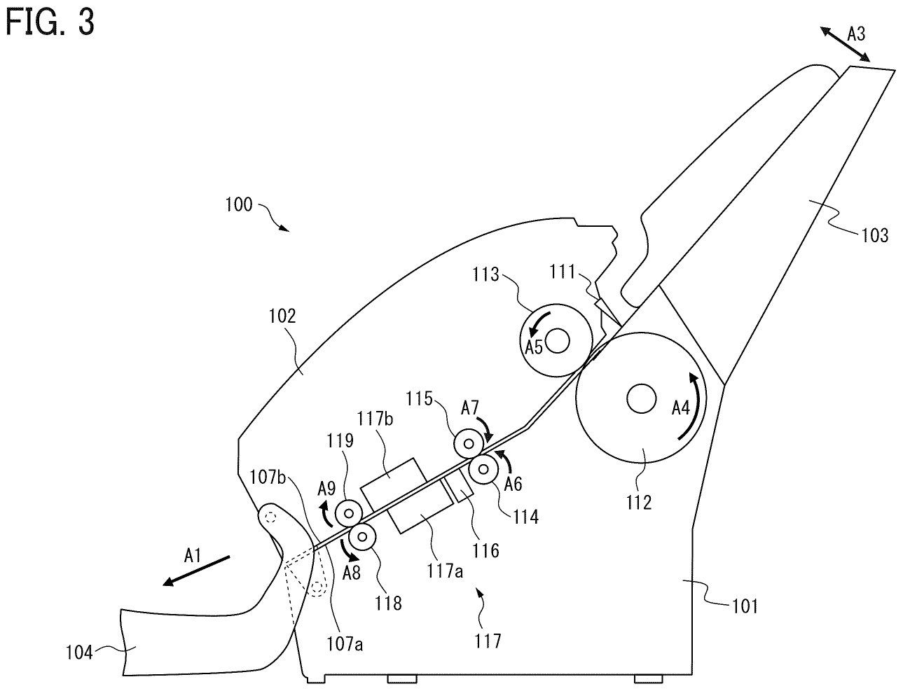

FIG. 3 is a diagram illustrating a conveyance passage inside the image reading apparatus 100.

The image reading apparatus 100 includes, along the conveyance passage, a first media sensor 111, a feeding roller 112, a separation roller 113, a first conveyance roller 114, a second conveyance roller 115, a second media sensor 116, an imaging device 117, a third conveyance roller 118, and a fourth conveyance roller 119. The number of each roller may be two or more not limited to one. When one or more of the above rollers are formed of multiple rollers, the multiple rollers are arranged at intervals in the width direction A2.

The image reading apparatus 100 has a so-called straight path. The upper face of the lower housing 101 forms a lower guide 107a for the conveyance passage of media (also “media conveyance passage” in the following description), and the lower face of the upper housing 102 forms an upper guide 107b for the media conveyance passage.

The first media sensor 111 is disposed upstream from the feeding roller 112 and the separation roller 113. The first media sensor 111 includes a contact detection sensor and detects whether a medium is placed on the medium tray 103. The first media sensor 111 generates and outputs a first media signal whose signal value changes depending on whether a medium is placed on the medium tray 103. The first media sensor 111 is not limited to a contact detection sensor. The first media sensor 111 may be any sensor such as an optical detection sensor that can detect the presence of a medium.

The feeding roller 112 is disposed in the lower housing 101 and sequentially feeds the media placed on the medium tray 103 from the bottom. The separation roller 113 is a so-called brake roller or retard roller and is disposed in the upper housing 102 and opposite to the feeding roller 112.

The first conveyance roller 114 and the second conveyance roller 115 are disposed downstream from the feeding roller 112 and the separation roller 113 and opposite to each other. The first conveyance roller 114 and the second conveyance roller 115 convey the media fed by the feeding roller 112 and the separation roller 113 to the imaging device 117.

The second media sensor 116 is disposed downstream from the first conveyance roller 114 and the second conveyance roller 115 and upstream from the imaging device 117, and detects the media conveyed to the position detected by the second media sensor 116. The second media sensor 116 includes a light emitter and a light receiver disposed on one side of the media conveyance passage (for example, the lower housing 101 side), and a light guide disposed opposite to the light emitter and the light receiver across the media conveyance passage (for example, the upper housing 102 side). The light emitter is, for example, a light-emitting diode (LED), and emits light toward the media conveyance passage. By contrast, the light receiver is, for example, a photodiode and receives the light that is emitted by the light emitter and guided by the light guide. When the medium is present at the position opposite to the second media sensor 116, the light emitted from the light emitter is blocked by the media, and the light receiver does not detect the light emitted from the light emitter. The light receiver generates and outputs a second media signal based on the intensity of the light received. The second media signal changes in signal value depending on whether a medium is present at the position of the second media sensor 116.

A reflector such as a mirror may be used instead of the light guide. The light emitter and the light receiver may be disposed opposite to each other across the media conveyance passage. Further, the second media sensor 116 may detect the medium using, for example, a contact detection sensor that allows a predetermined amount of current to flow when the medium is in contact or not in contact therewith.

The imaging device 117 is an example of an imager. The imaging device 117 is disposed downstream from the first conveyance roller 114 and the second conveyance roller 115 and upstream from the third conveyance roller 118 and the fourth conveyance roller 119. The imaging device 117 includes a first imaging device 117a and a second imaging device 117b. The first imaging device 117a and the second imaging device 117b are disposed near the media conveyance passage and opposite to each other across the media conveyance passage.

The first imaging device 117a includes a light source and an equal-magnification contact image sensor (CIS) as a line sensor. The CIS includes complementary metal oxide semiconductor (CMOS) imaging elements aligned linearly in the main-scanning direction. The first imaging device 117a further includes a lens that forms an image on the imaging elements and an analog-to-digital (A/D) converter. The A/D converter amplifies the electrical signals output from the imaging elements and performs analog-to-digital (A/D) conversion. The first imaging device 117a acquires an input image by imaging the front side of each of the media sequentially conveyed by the conveyor, and outputs the input image.

Similarly, the second imaging device 117b includes a light source and, as a line sensor, an equal-magnification CIS including CMOS imaging elements aligned linearly in the main-scanning direction. The second imaging device 117b further includes a lens that forms an image on the imaging elements and an A/D converter. The A/D converter amplifies the electrical signals output from the imaging elements and performs A/D conversion. The second imaging device 117b acquires an input image by imaging the back side of each of the media sequentially conveyed by the conveyor, and outputs the input image.

Alternatively, the image reading apparatus 100 may include either the first imaging device 117a or the second imaging device 117b to read only one side of the medium. Further, the line sensor may be, instead of the equal-magnification CIS including CMOS imaging elements, an equal-magnification CIS including charge-coupled device (CCD) imaging elements. Alternatively, a line sensor employing a reduction optical system and including CMOS or CCD imaging elements may be used.

The third conveyance roller 118 and the fourth conveyance roller 119, which are disposed downstream from the imaging device 117 and opposite to each other, eject the medium conveyed by the first conveyance roller 114 and the second conveyance roller 115 onto the ejection tray 104.

The media placed on the medium tray 103 are conveyed between the lower guide 107a and the upper guide 107b in the media conveyance direction A1 by the feeding roller 112 rotating in the direction indicated by arrow A4 in FIG. 3. The separation roller 113 rotates or stops in the direction indicated by arrow A5 in FIG. 3 when conveying the media. When multiple media are placed on the medium tray 103, only the medium in contact with the feeding roller 112 is separated from the rest of the media on the medium tray 103 due to the action of the feeding roller 112 and separation roller 113. This operation prevents the feeding of a medium other than the separated medium (prevents multiple feeding).

The medium is fed between the first conveyance roller 114 and the second conveyance roller 115 while being guided by the lower guide 107a and the upper guide 107b. The medium is fed between the first imaging device 117a and the second imaging device 117b by the first conveyance roller 114 rotating in the direction of arrow A6 in FIG. 3 and the second conveyance roller 115 rotating in the direction of arrow A7 in FIG. 3. The medium read by the imaging device 117 is ejected onto the ejection tray 104 by the third conveyance roller 118 rotating in the direction of arrow A8 in FIG. 3 and the fourth conveyance roller 119 rotating in the direction of arrow A9 in FIG. 3.

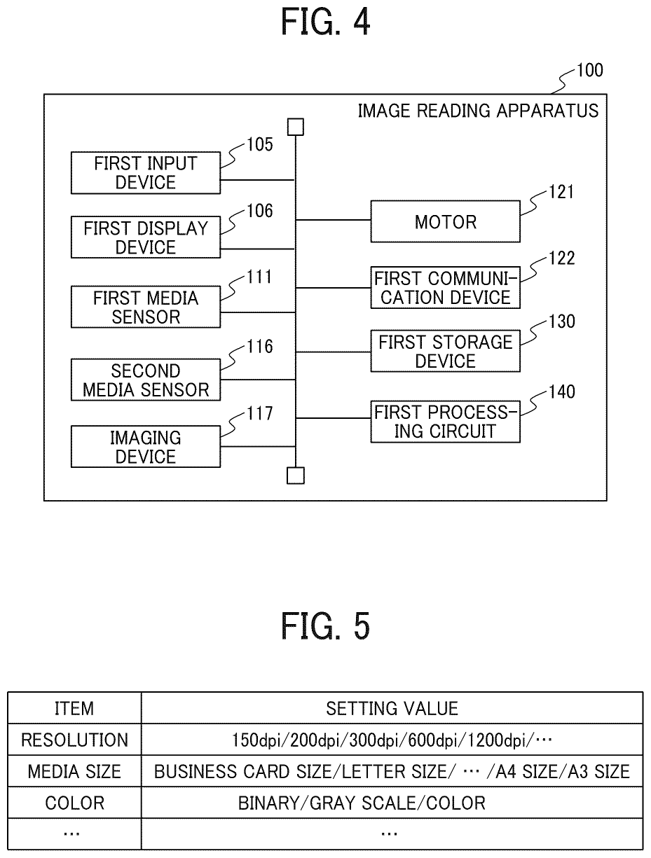

FIG. 4 is a block diagram illustrating a schematic configuration of the image reading apparatus 100 according to the present embodiment.

In addition to the above-described components, the image reading apparatus 100 includes a motor 121, a first communication device 122, a first storage device 130, and a first processing circuit 140.

The motor 121 includes one or multiple motors. The motor 121 rotates the feeding roller 112, the separation roller 113, the first conveyance roller 114, the second conveyance roller 115, the third conveyance roller 118, and the fourth conveyance roller 119 in response to a control signal from the first processing circuit 140 to convey the medium. One of the first conveyance roller 114 and the second conveyance roller 115 may be a driven roller that rotates following the other roller. One of the third conveyance roller 118 and the fourth conveyance roller 119 may be a driven roller that rotates following the other roller.

The first communication device 122 includes an antenna that transmits and receives wireless signals, and a wireless communication interface circuit for transmitting and receiving signals through a wireless communication line according to a communication protocol such as a wireless local area network (LAN) protocol. The first communication device 122 can communicate with the information processing apparatus 200. According to an instruction from the first processing circuit 140, the first communication device 122 transmits and receives various images and information to and from the information processing apparatus 200 through the network N. The first communication device 122 may include a wired communication interface circuit supporting a communication protocol such as the Transmission Control Protocol/Internet Protocol (TCP/IP) and connect to the information processing apparatus 200 through a network. The first communication device 122 may have an interface circuit compatible with a serial bus such as the Universal Serial Bus (USB) and may be connected to the information processing apparatus 200 via a wired cable such as a USB cable.

The first storage device 130 includes memories such as a random-access memory (RAM) and a read-only memory (ROM); a fixed disk device such as a hard disk; or a portable memory such as a flexible disk or an optical disk. The first storage device 130 stores, for example, computer programs, databases, and tables used for various processes performed by the image reading apparatus 100. The computer programs may be installed in the first storage device 130 using, for example, a known setup program from a computer-readable portable recording medium. The portable recording medium is, for example, a compact disc read-only memory (CD-ROM) or a digital versatile disc read-only memory (DVD-ROM). Alternatively, the computer programs may be distributed from a server and installed in the first storage device 130.

Further, data such as a setting information table is prestored in the first storage device 130. The setting information includes a setting value for each of multiple items. The setting information may include a setting value on only a single item. Details of the setting information table are deferred.

The first processing circuit 140 operates according to a program stored in the first storage device 130 in advance. The first processing circuit 140 is, for example, a central processing unit (CPU). Alternatively, the first processing circuit 140 may be implemented by, for example, a digital signal processor (DSP), a large scale integration (LSI), an application-specific integrated circuit (ASIC), or a field-programmable gate array (FPGA).

The first processing circuit 140 is connected to, for example, the first input device 105, the first display device 106, the first media sensor 111, the second media sensor 116, the imaging device 117, the motor 121, the first communication device 122, and the first storage device 130 and controls these components. The first processing circuit 140 controls, for example, the driving of the motor 121 and the imaging by the imaging device 117 to acquire an input image according to the setting information designated by the user (first setting information) via the first input device 105 or the first communication device 122. The first processing circuit 140 determines whether the designated setting information matches the feature of the input image. When determining that the designated setting information does not match the feature of the input image, the first processing circuit 140 outputs display data for displaying a processed image acquired by processing the input image according to the setting information matching the feature of the input image.

FIG. 5 is a schematic diagram illustrating a data structure of the setting information table according to the present embodiment.

As illustrated in FIG. 5, the setting information table stores one or more setting values settable for each of one or more setting items specified by the setting information. The setting information is information regarding an input image generation process in the image reading apparatus 100. The information regarding the input image generation process is information regarding at least one of imaging processing and image processing in the image reading apparatus 100. In other words, the setting information is information on settings of a generating process for acquiring a desired input image, including at least one of imaging processing and image processing. For example, the setting information specifies the operation conditions of the image reading apparatus 100 for imaging a medium. Alternatively, the setting information specifies the content of image processing to be executed on the image acquired by the imaging. Items specified by the setting information include resolution, media size, and color (color mode).

Resolution, media size, and color are setting items relating to imaging processing. Resolution, media size, and color are also setting items relating to image processing.

The resolution is the setting of the resolution of an image to be generated. The setting value of the resolution is, for example, 150 dots per inch (dpi), 200 dpi, 300 dpi, 600 dpi, or 1200 dpi. The image reading apparatus 100 generates an image of a set resolution by setting imaging conditions such as the media conveyance speed, the imaging timing (time interval) of the imaging device 117, and the positions of the imaging elements in the line sensor to be used. Further, the image reading apparatus 100 generates an image of a set resolution by executing, in the image processing, thinning or interpolation of the image generated in the imaging processing.

The media size is the setting of the size of the medium included in the image to be generated. Examples of setting value of the media size include business card size, letter size, A4 size, A3 size, and automatic (auto). The image reading apparatus 100 can generate an input image including an image of a medium of the specified media size by setting imaging conditions such as the timing at which the imaging device 117 finishes the imaging, and the positions of the imaging elements in the line sensor to be used. Further, the image reading apparatus 100 can generate a processed image including an image of a medium of the specified media size by executing, in the image processing, cropping of the image generated in the imaging processing.

The color is the setting of the color mode of an image to be generated. Examples of the setting value of the color include binary, gray scale, and color. The image reading apparatus 100 can change the color of the image to be generated by setting, for example, the color of the light emitted by the light source of the imaging device 117 and the gradation range converted by the A/D converter in the imaging processing. Further, the image reading apparatus 100 can change the color of the image to be generated by executing, in the image processing, for example, grayscale conversion or binarization of the color image generated in the imaging processing.

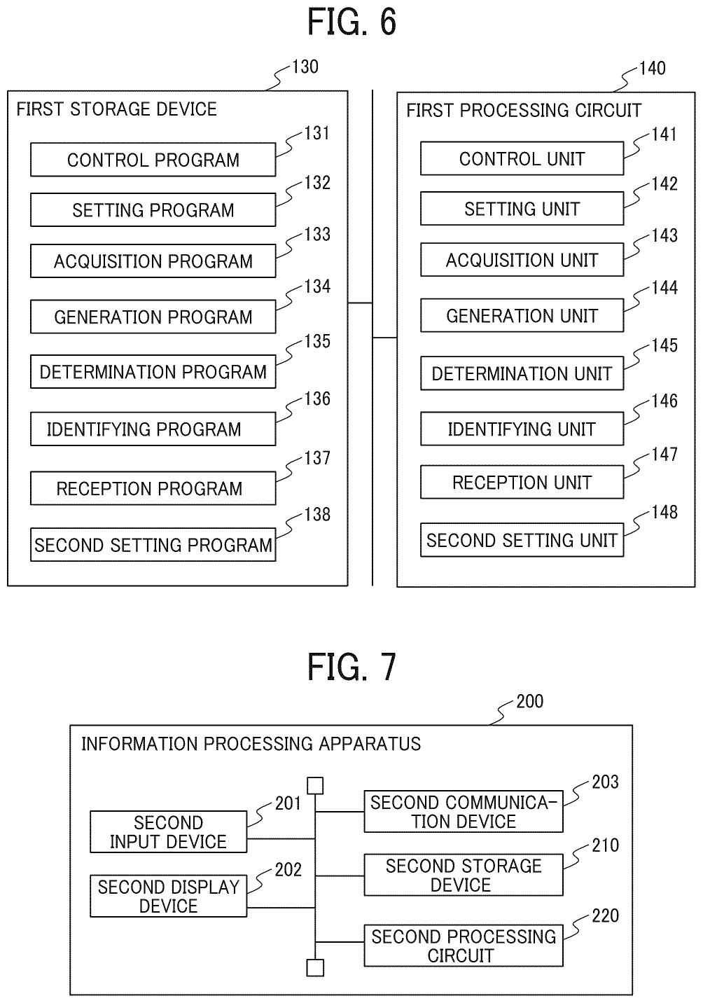

FIG. 6 is a diagram illustrating a schematic configuration of the first storage device 130 and the first processing circuit 140 according to the present embodiment.

As illustrated in FIG. 6, the first storage device 130 stores programs such as a control program 131, a setting program 132, an acquisition program 133, a generation program 134, a determination program 135, an identifying program 136, a reception program 137, and a second setting program 138. These programs are functional modules implemented by software operating on a processor. The first processing circuit 140 reads the programs stored in the first storage device 130 and operates according to the read programs, thereby functioning as a control unit 141, a setting unit 142, an acquisition unit 143, a generation unit 144, a determination unit 145, an identifying unit 146, a reception unit 147, and a second setting unit 148.

FIG. 7 is a schematic block diagram illustrating a configuration of the information processing apparatus 200 according to the present embodiment.

The information processing apparatus 200 includes a second input device 201, a second display device 202, a second communication device 203, a second storage device 210, and a second processing circuit 220.

The second input device 201 includes an input device such as a keyboard and a mouse, and an interface circuit that acquires signals from the input device. The second input device 201 outputs a signal corresponding to the operation performed by the user to the second processing circuit 220.

The second display device 202 includes a display, which may be a liquid crystal or organic electro-luminescence (EL) display, and an interface circuit to output image data to the display. The second display device 202 displays various types of information according to instructions from the second processing circuit 220.

The second communication device 203 includes an antenna that transmits and receives wireless signals, and a wireless communication interface circuit that transmits and receives signals through a wireless communication line according to a predetermined communication protocol such as the wireless LAN protocol. The second communication device 203 communicates with the image reading apparatus 100. The second communication device 203 transmits and receives various images and information to and from the image reading apparatus 100 according to an instruction from the second processing circuit 220. The second communication device 203 may include a wired communication interface circuit supporting a communication protocol such as the TCP/IP and connect to the image reading apparatus 100 through a network. Further, the second communication device 203 may include an interface circuit compatible with a serial bus such as the USB, and may be connected to the image reading apparatus 100 via a wired cable such as the USB cable.

The second storage device 210 includes memories such as a RAM or ROM; a fixed disk device such as a hard disk; or a portable storage device such as a flexible disk or an optical disk. The second storage device 210 stores, for example, computer programs, databases, and tables used in various processes performed by the information processing apparatus 200. The computer program may be installed in the second storage device 210 from a computer-readable portable recording medium such as the CD-ROM or the DVD-ROM using, for example, a known setup program. Further, the computer program may be distributed from a server and installed in the second storage device 210.

The second processing circuit 220 operates according to a program stored in the second storage device 210 in advance. The second processing circuit 220 is, for example, a CPU. Alternatively, the second processing circuit 220 may be implemented by, for example, a DSP, an LSI, an ASIC, or an FPGA.

The second processing circuit 220 is connected to, for example, the second input device 201, the second display device 202, the second communication device 203, and the second storage device 210 and controls these devices. The second processing circuit 220 controls, for example, data transmission/reception with the image reading apparatus 100 via the second communication device 203, input operation of the second input device 201, and display operation of the second display device 202.

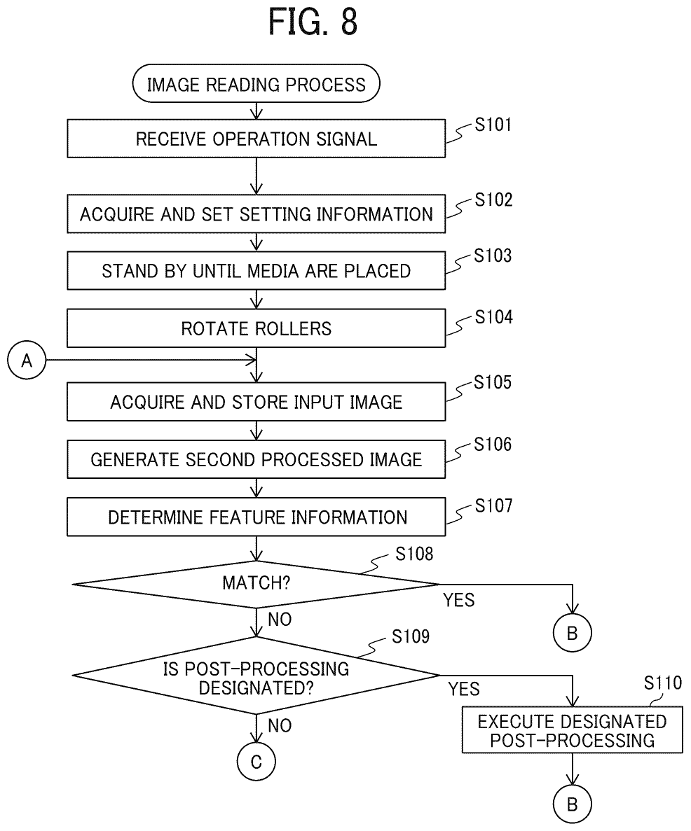

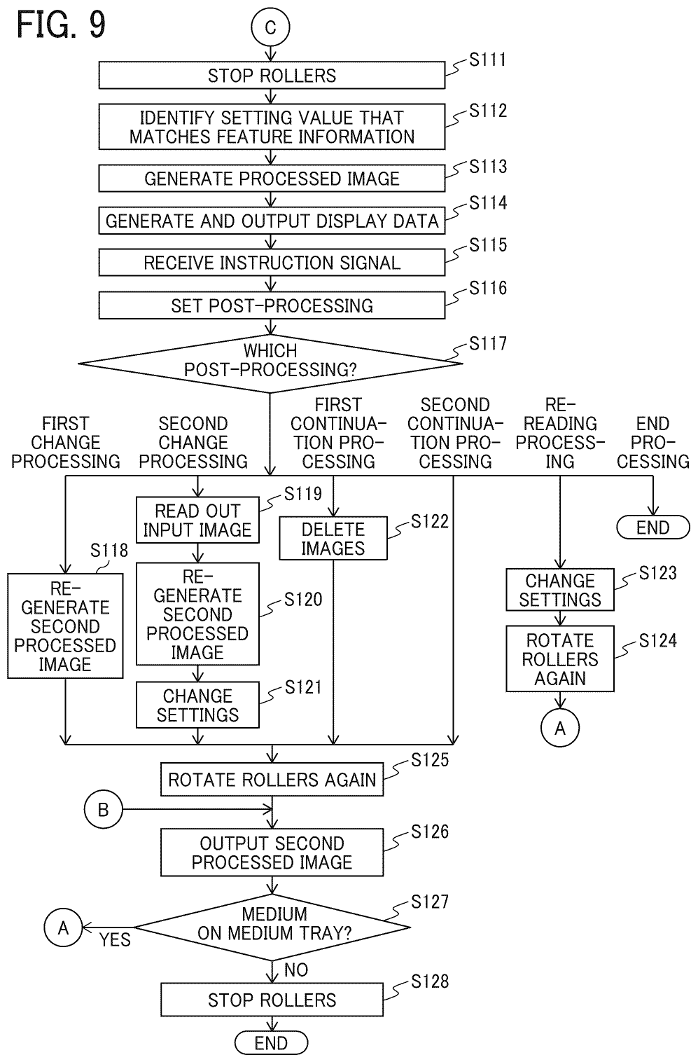

FIGS. 8 and 9 are flowcharts illustrating an image reading process according to the present embodiment.

A description is given below of example operations in the image reading process performed by the image reading apparatus 100 with reference to the flowcharts in FIGS. 8 and 9. The operation process described below is executed, for example, by the first processing circuit 140 in cooperation with the components of the image reading apparatus 100 according to the program prestored in the first storage device 130.

The control unit 141 stands by until a reading instruction to read media is input by the user using the first input device 105 or the information processing apparatus 200 and an operation signal instructing to read the medium is received from the first input device 105 or the first communication device 122 (step S101). The operation signal includes setting information designated by the user using the first input device 105 or the information processing apparatus 200 along with a reading instruction.

Subsequently, the setting unit 142 acquires the setting information included in the operation signal and sets (stores) the setting information in the first storage device 130. The setting unit 142 sets, in the first storage device 130, the setting information of the components such as the imaging device 117 and the motor 121 to generate an input image according to the acquired setting information (step S102). The setting unit 142 sets, in the first storage device 130, the setting information of the components such as the imaging device 117 and the motor 121 to generate an input image whose quality is equal to or higher the image quality according to the setting information. For example, the setting unit 142 sets the components such as the imaging device 117 and the motor 121 to generate an input image having the maximum resolution supported by the image reading apparatus 100 and the maximum media size supported by the image reading apparatus 100 in color. As a result, the image reading apparatus 100 can appropriately determine whether the setting information matches the feature of the input image in the processing described below based on the input image.

The setting information may not be designated together with the reading instruction, and may be designated by the user and stored in the first storage device 130 before the reading instruction is input. In that case, the setting unit 142 acquires the setting information by reading the setting information from the first storage device 130. Further, the control unit 141 sets (initializes) the media number of the medium to be conveyed to 1.

Subsequently, the control unit 141 stands by until a medium is placed on the medium tray 103 (step S103). The control unit 141 acquires a first media signal from the first media sensor 111 and determines whether media are placed on the medium tray 103 based on the acquired first media signal.

The control unit 141 then drives the motor 121 to rotate the feeding roller 112, the separation roller 113, the first conveyance roller 114, the second conveyance roller 115, the third conveyance roller 118, and/or the fourth conveyance roller 119 (step S104). Thus, the control unit 141 feeds the media from the medium tray 103. The control unit 141 rotates the motor 121 at a speed that allows the generation of an input image according to the setting information acquired in step S102, in particular, an input image with the resolution specified by the setting information.

Subsequently, the acquisition unit 143 acquires the input image in which the conveyed medium is imaged from the imaging device 117, and stores the input image in the first storage device 130 in association with the media number (step S105).

For example, the acquisition unit 143 determines whether the leading end of the medium has passed the position of the second media sensor 116 based on the second media signal received from the second media sensor 116. The acquisition unit 143 acquires the second media signal periodically from the second media sensor 116 and determines that the leading end of the medium has passed the position of the second media sensor 116 when the signal value of the second media signal changes from a value indicating the absence of a medium to a value indicating the presence of a medium. The acquisition unit 143 controls the imaging device 117 to start imaging when the leading end of the medium has passed the position of the second media sensor 116. The control unit 141 controls the imaging device 117 to generate the input image according to the setting information acquired in step S102.

Then, the acquisition unit 143 controls the imaging device 117 to end imaging when the medium has been conveyed by the amount of the media size indicated by the setting information acquired in step S102 plus the margin. The acquisition unit 143 may control the imaging device 117 to end the imaging when the trailing end of the medium has passed the imaging position of the imaging device 117. For example, the acquisition unit 143 determines whether the trailing end of the medium has passed the position of the second media sensor 116 based on the second media signal received from the second media sensor 116. The acquisition unit 143 acquires the second media signal periodically from the second media sensor 116 and determines that the leading end of the medium has passed the position of the second media sensor 116 when the signal value of the second media signal changes from a value indicating the presence of a medium to a value indicating the absence of a medium. The acquisition unit 143 determines that the trailing end of the medium has passed the imaging position of the imaging device 117 when a first predetermined time has elapsed after the trailing end of the medium passes the position of the second media sensor 116. The first predetermined time is set to the time taken for the medium to move from the second media sensor 116 to the imaging position.

The acquisition unit 143 acquires the input image data from the imaging device 117 every time the imaging device 117 generates predetermined lines of the input image, and synthesizes the input image data when the imaging device 117 ends the imaging. The control unit 141 may acquire the input image data of all the lines at a time when the imaging device 117 ends the imaging.

Subsequently, the generation unit 144 processes the input image in accordance with the setting information designated by the user to generate a processed image, and stores the processed image in the first storage device 130 in association with the media number (step S106). As described later, an image acquired by processing an input image according to the setting information identified by the identifying unit 146 (second setting information) when the setting value does not match the feature information is also referred to as a first processed image in the following description. By contrast, an image acquired by processing an input image according to the setting information designated by the user is also referred to as a second processed image.

Subsequently, the determination unit 145 determines multiple feature information in the input image (step S107).

Each feature information indicates a feature of an input image relating to the imaging processing or the image processing, in particular, a feature of a conveyed medium imaged in the input image. Items specified by the feature information include the presence of a photograph, size, and color component. Each feature information relates to one or more setting items specified by the setting information.

The item “presence of a photograph” indicates whether the input image includes a photograph and relates to, for example, the resolution or color among the setting items specified by the setting information. For example, the determination unit 145 determines whether an input image includes a photograph using a discriminator trained in advance to output information indicating whether an image includes a photograph when the image is input. The discriminator is trained in advance by, for example, deep learning using images including various photographs and is prestored in the first storage device 130. The determination unit 145 inputs the input image to the discriminator and determines whether the input image includes a photograph based on the information output from the discriminator.

The determination unit 145 may determine whether the input image includes a photograph based on the spatial frequencies of the input image. In this case, the determination unit 145 performs frequency conversion such as Fourier transform on the input image to acquire the spatial frequency distribution in the input image. The determination unit 145 determines that the input image includes a photograph when the maximum of the spatial frequencies in the input image is equal to or greater than a frequency threshold and determines that the input image includes no photograph when the maximum of the spatial frequencies in the input image smaller than the frequency threshold. Alternatively or additionally, the determination unit 145 may determine whether the input image includes a photograph based on the distribution of pixel values such as brightness values or color values of pixels in the input image. In this case, the determination unit 145 calculates the variance of the pixel values in the input image. The determination unit 145 determines that the input image includes a photograph when the calculated variance is equal to or greater than a variance threshold and determines that the input image includes no photograph when the calculated variance is smaller than the variance threshold.

The item “size” indicates the size of the medium whose image is included in the input image (i.e., the medium imaged in the input image) and is related to the media size and the like among the items specified by the setting information. For example, the determination unit 145 extracts edge pixels having a pixel value (e.g., brightness value or color value) that differs from the pixel value of the adjacent pixel by a threshold value or greater in the input image and detects the largest area among areas surrounded by the edge pixels adjacent to each other as a medium area. The determination unit 145 identifies the size of the medium imaged in the input image based on the number of pixels of the detected medium area and the resolution set at the generation of the input image is generated.

The item “color component” indicates the color components (color or black and white) included in the input image and relates to, for example, the color among the setting items specified by the setting information. For example, the determination unit 145 determines whether the input image includes color components or black and white components based on the distribution of the color values (such as the R value, G value, or B value) of the pixels in the input image. The determination unit 145 calculates the variance of the color values of the pixels in the input image. The determination unit 145 determines that the input image includes color components when the average value of the calculated variances is equal to or greater than a variance threshold and determines that the input image includes black and white components when the average value of the calculated variances is smaller than the variance threshold.

The determination unit 145 then determines whether the setting information set by the user matches the features of the input image based on the input image (step S108). The determination unit 145 determines, for each of one or more setting items specified by the setting information, whether the setting value set by the user matches the feature of the input image, i.e., the feature information relating to the item of the input image.

Regarding the resolution, in the case of having determined that the input image includes a photograph as the feature information, the determination unit 145 determines that the setting value matches the feature information when the setting value is equal to or greater than a resolution threshold, and determines that the setting value does not match the feature information when the setting value is smaller than the resolution threshold. The resolution threshold is set to a value (e.g., 200 dpi) between a resolution at which an image including a photograph is preferably displayed for viewing and a resolution at which an image including a photograph is displayed unsuitable for viewing. The resolution threshold may be set to any desired value (e.g., 300 dpi). By contrast, in the case of having determined that the input image includes no photograph as the feature information, the determination unit 145 determines that the setting value matches the feature information when the setting value is smaller than the resolution threshold, and determines that the setting value does not match the feature information when the setting value is equal to or greater than the resolution threshold.

Regarding the media size, the determination unit 145 determines that the setting value matches the feature information when a difference between the size determined as the feature information and the setting value is equal to or smaller than a size threshold, and determines that the feature information does not match the setting value when the difference is greater than the size threshold. The size threshold is preset to any desired value (e.g., the difference between A3 size and A4 size). The size threshold may be set to 0. In other words, the determination unit 145 may determine that the setting value matches the feature information when the size determined as the feature information matches the setting value, and may determine that the setting value does not match the feature information when the size determined as the feature information does not match the setting value.

Regarding the color, in the case of having determined that the input image includes a photograph as the feature information, the determination unit 145 determines that the setting value matches the feature information when the setting value is color, and determines that the setting value does not match the feature information when the setting value is grayscale or binary. By contrast, in the case of having determined that the input image includes no photograph as the feature information, the determination unit 145 determines that the setting value matches the feature information when the setting value is grayscale or binary, and determines that the setting value does not match the feature information when the setting value is color.

Further, regarding the color, in the case of having determined that the color components are colors as the feature information, the determination unit 145 determines that the setting value matches the feature information when the setting value is color, and determines that the setting value does not match the feature information when the setting value is grayscale or binary. By contrast, in the case of having determined that the color components are black and white as the feature information, the determination unit 145 determines that the setting value matches the feature information when the setting value is grayscale or binary, and determines that the setting value does not match the feature information when the setting value is color.

The determination unit 145 determines that the setting information designated by the user does not match the feature of the input image when determining that the setting value of any one item does not match the feature information. By contrast, when determining that the setting values of all the items match the feature information, the determination unit 145 determines that the setting information designated by the user matches the features of the input image. When determining that the setting information matches the features of the input image (Yes in S108), the determination unit 145 proceeds to step S126 in FIG. 9.

By contrast, if it is determined that the setting information does not match the features of the input image, the control unit 141 determines whether the reception unit 147 has received the designation of post-processing for the combination of that setting information and that feature information of the input image in the past (step S109). The designation of the post-processing is received in the process described later.

When the reception unit 147 has received the designation of post-processing for the combination of that setting information and that feature information of the input image in the past, the control unit 141 executes the post-processing designated for the combination in the past (step S110) and proceeds to step S126. In this case, the control unit 141 may display on the first display device 106 a notification of executing the post-processing designated in the past for that combination or transmit the notification to the information processing apparatus 200 via the first communication device 122, to notify the user of the execution. When receiving the notification from the image reading apparatus 100 via the second communication device 203, the information processing apparatus 200 displays the received notification on the second display device 202.

By contrast, when the reception unit 147 has not received the designation of the post-processing from the user for the combination of that setting information and that feature information of the input image in the past, the control unit 141 stops the motor 121. As a result, the control unit 141 stops the feeding roller 112, the separation roller 113, the first conveyance roller 114, the second conveyance roller 115, the third conveyance roller 118, and/or the fourth conveyance roller 119, and suspends conveying subsequent media (step S111).

Subsequently, the identifying unit 146 identifies setting information that matches the feature of the input image and stores the setting information in the first storage device 130 in association with the media number (step S112). The identifying unit 146 identifies a setting value that matches the feature information for each item for which it is determined in step S108 that the user-designated setting value does not match the feature of the input image, that is, the feature information related to the feature item of the input image.

In the case of having determined that the setting value of the resolution does not match the feature information, the identifying unit 146 identifies the minimum of the setting values equal to or larger than the resolution threshold as the setting value matching the feature information when it is determined that the input image includes a photograph as the feature information. In this case, the identifying unit 146 may identify the maximum of the setting values as the setting value matching the feature information. By contrast, in the case of having determined that the input image includes no photograph as the feature information, the identifying unit 146 identifies the maximum of the setting values smaller than the resolution threshold as the setting value matching the feature information. In this case, the identifying unit 146 may identify the minimum of the setting values as the setting value matching the feature information.

In the case of having determined that the setting value of the media size does not match the feature information, the identifying unit 146 identifies the size determined as the feature information as the setting value matching the feature information.

In the case of having determined that the setting value of the color does not match the feature information, the identifying unit 146 identifies color as the setting value matching the feature information when it is determined that the input image includes a photograph as the feature information. By contrast, when it is determined that the input image includes no photograph as the feature information, the identifying unit 146 identifies gray scale or binary as the setting value matching the feature information. Alternatively, when the color components are determined as color as the feature information, the identifying unit 146 may identify color as the setting value matching the feature information. In this case, when the color components are identified as black and white as the feature information, the identifying unit 146 identifies gray scale or binary as the setting value matching the feature information.

In this way, when it is determined that the setting information does not match the features of the input image, the identifying unit 146 identifies the setting information matching the features of the input image.

Subsequently, the generation unit 144 processes the input image in accordance with the setting information identified by the identifying unit 146 to generate a processed image, and stores the processed image in the first storage device 130 in association with the media number (step S113). The generation unit 144 generates a processed image in accordance with the setting value identified by the identifying unit 146 for the setting item determined as having a value mismatched with the features of the input image and in accordance with the setting value designated by the user for the other setting items. The generation unit 144 may generate a different processed image for each setting item determined as having a value mismatched with the features of the input image. In this case, the generation unit 144 generates a processed image in accordance with the setting value identified by the identifying unit 146 for each setting item determined as a value mismatched with the features of the input image and in accordance with the setting value designated by the user for the other setting items.

Further, the generation unit 144 determines whether generating a processed image according to the setting information identified by the identifying unit 146 from the input image is feasible. When generating the processed image according to the identified setting information is not feasible, the generation unit 144 does not perform the generation.

For example, the generation unit 144 does not generate the processed image when the resolution identified by the identifying unit 146 is higher than the resolution of the input image generated by the imaging device 117. For example, when the user-designated resolution is low (for example, 150 dpi), the setting unit 142 sets the resolution of the input image generated by the imaging device 117 to a resolution (for example, 300 dpi) lower than the maximum resolution (for example, 600 dpi). As a result, the image reading apparatus 100 can appropriately generate the second processed image while attaining a high conveyance speed of media. By contrast, in this case, when the resolution (for example, 600 dpi) identified by the identifying unit 146 is higher than the resolution of the input image generated by the imaging device 117, the generation unit 144 cannot generate a processed image having the identified resolution and thus does not generate the processed image.

Similarly, the generation unit 144 does not generate a processed image when the size identified by the identifying unit 146 is larger than the size of the input image generated by the imaging device 117. For example, when the user-designated media size is small (e.g., letter size), the setting unit 142 sets the size of the input image generated by the imaging device 117 to a size (e.g., A5 size) smaller than the maximum size (e.g., A4 size). As a result, the image reading apparatus 100 can appropriately generate the second processed image while attaining a high conveyance speed of media. By contrast, in this case, when the size (for example, the A4 size) identified by the identifying unit 146 is larger than the size of the input image generated by the imaging device 117, the generation unit 144 cannot generate a processed image having the identified size and thus does not generate the processed image.

Subsequently, the control unit 141 generates display data for displaying the processed image generated by the generation unit 144 and outputs the display data by displaying the display data on the first display device 106 or transmitting the display data to the information processing apparatus 200 via the first communication device 122 (step S114). When receiving the display data from the image reading apparatus 100 via the second communication device 203, the information processing apparatus 200 displays the received display data on the second display device 202.

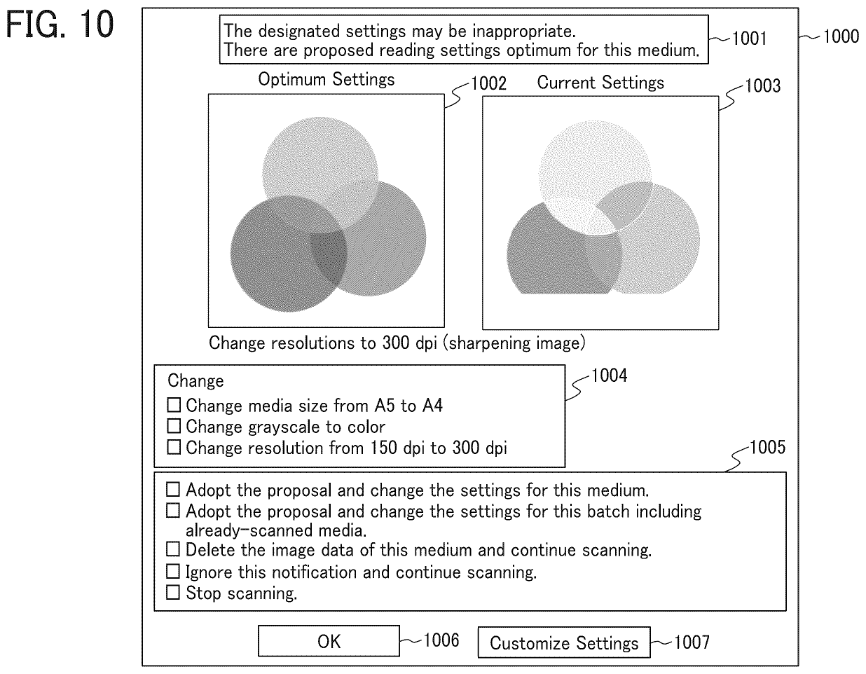

FIG. 10 is a schematic diagram illustrating an example of display data 1000.

As illustrated in FIG. 10, the display data 1000 includes a summary 1001, a processed image 1002, a second processed image 1003, a change object 1004, a processing object 1005, an OK button 1006, and a customize button 1007.

The summary 1001 includes the determination result by the determination unit 145, i.e., the message that the setting information designated by the user does not match the features of the input image, and the determination result by the identifying unit 146, i.e., the recommendation of setting information matching the features of the input image.

The processed image 1002 is a processed image acquired by processing the input image in accordance with the setting information identified by the identifying unit 146. When the generation unit 144 generates a processed image in accordance with the setting value identified by the identifying unit 146 for each of the multiple items each determined as having a value mismatched with the features of the input image, the multiple generated processed images may be displayed as the processed images 1002. The user can appropriately determine whether to change the setting value of each item by referring to the processed image generated corresponding to the item for each setting item whose value is determined as being mismatched with the features of the input image. In addition, text indicating the content of the changed setting information and/or the reason for the change (for example, to make the characters clear or to make the color clear) may be displayed in association with each processed image.

The second processed image 1003 is the second processed image acquired by processing the input image in accordance with the setting information designated by the user. In this way, the control unit 141 generates display data such that the processed image and the second processed image are displayed adjacent to each other (e.g., side by side). Thus, the user can appropriately determine whether to change the setting information by visually comparing the processed image and the second processed image. Note that the second processed image 1003 does not have to be displayed. In addition, when the processed image 1002 is similar in visual to the second processed image 1003 (for example, the difference in resolution is slight), the second processed image 1003 does not have to be displayed.

The change object 1004 is an object for changing the setting information designated by the user to the setting information identified by the identifying unit 146 and matching the features of the input image. The change object 1004 includes a button for designating whether to change the setting value designated by the user to the setting value matching the feature information for each setting item determined as having a value mismatched with the features of the input image.

The processing object 1005 is an object for designating post-processing to be executed in the subsequent stage. The processing object 1005 includes a button for designating some kind of post-processing. The post-processing includes first change processing, second change processing, first continuation processing, second continuation processing, and end processing.

The first change processing is the processing of changing only the setting information for the input image generated this time to the setting information designated by the change object 1004. For example, when the media collectively placed on the medium tray 103 include a different type of medium different from the rest, the user can acquire the second processed image generated according to appropriate setting information for the different type of medium by designating the first change processing.

The second change processing is the processing of changing the setting information for all the media collectively placed on the medium tray 103 to the setting information designated by the change object 1004. The user can acquire the second processed image generated according to the setting information proposed by the image reading apparatus 100 for each of the media collectively placed on the medium tray 103 by designating the second change processing.

The first continuation processing is the processing of continuing the subsequent image reading process without changing the current setting information (the setting information designated by the user) while deleting the second processed image generated this time. For example, when the media collectively placed on the medium tray 103 include only one different type medium, the user can continue the image reading process according to the designated setting information while deleting the second processed image acquired by imaging the medium just conveyed by designating the first continuation processing. The user can take out the medium just conveyed from the ejection tray 104, change the setting information after the image reading process of the media collectively placed on the medium tray 103 completes, and execute the image reading process of only that medium.

The second continuation processing is the processing of continuing the subsequent image reading process without changing the current setting information (the setting information designated by the user). The user can ignore the proposal from the image reading apparatus 100 and continue the image reading process by designating the second continuation processing.

The end processing is the processing of ending the image reading process. The user can end the image reading process and re-execute the image reading process in accordance with desired setting information by designating the end processing.

The OK button 1006 is for changing the current setting information to the setting information designated by the change object 1004 and/or executing the post-processing designated by the processing object 1005. The customize button 1007 is for changing the setting information as desired. When the customize button 1007 is pressed, a screen (not illustrated) for setting again the setting information is displayed. The user can change the setting information to any desired setting information not limited to the setting information proposed from the image reading apparatus 100 by pressing the customize button 1007.

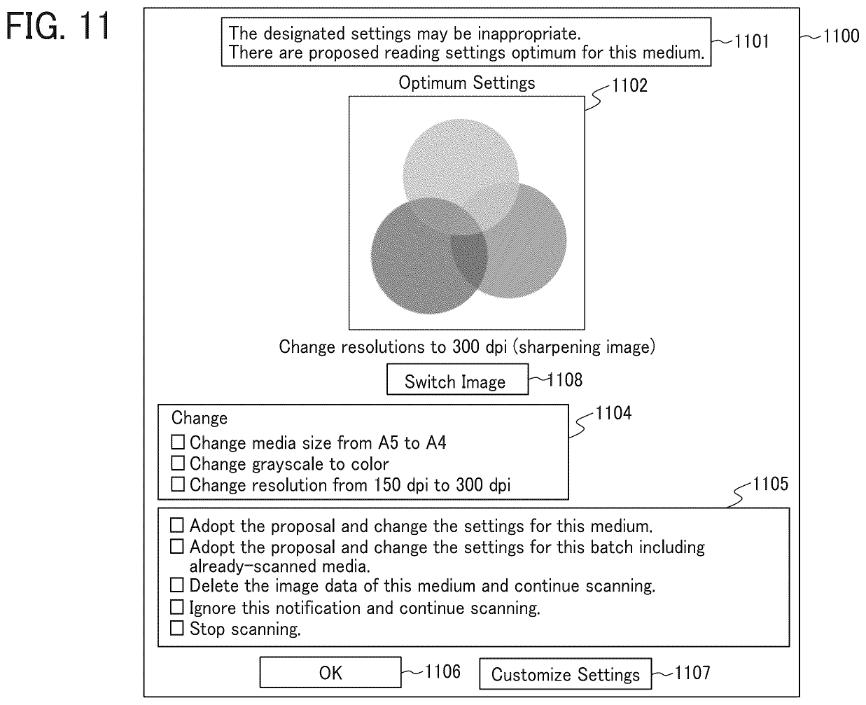

FIG. 11 is a schematic diagram illustrating display data 1100 as another example of the display data.

The display data 1100 is displayed instead of the display data 1000. As illustrated in FIG. 11, the display data 1100 includes a switch button 1108 (labeled as “switch image”) in addition to a summary 1101, a processed image 1102, a change object 1104, a processing object 1105, an OK button 1106, and a customize button 1107. The summary 1101, the processed image 1102, the change object 1104, the processing object 1105, the OK button 1106, and the customize button 1107 are information, objects, or buttons similar to the summary 1001, the processed image 1002, the change object 1004, the processing object 1005, the OK button 1006, and the customize button 1007, respectively.

The switch button 1108 is for switching the image displayed in the display data 1100 between the processed image 1102 and the second processed image. Each time the switch button 1108 is pressed on the display data 1100, the processed image 1102 and the second processed image are alternately displayed. In this way, the control unit 141 generates display data such that the processed image and the second processed image are displayed in place of each other. Thus, the user can appropriately determine whether to change the setting information by visually comparing the processed image and the second processed image.

When the generation unit 144 fails to generate the processed image according to the setting information identified by the identifying unit 146 from the input image, the control unit 141 generates second display data for requesting generation of an input image that can be processed according to the setting information identified by the identifying unit 146. The control unit 141 outputs the generated second display data by displaying the second display data on the first display device 106 or transmitting the second display data to the information processing apparatus 200 via the first communication device 122. When receiving the second display data from the image reading apparatus 100 via the second communication device 203, the information processing apparatus 200 displays the second display data on the second display device 202.

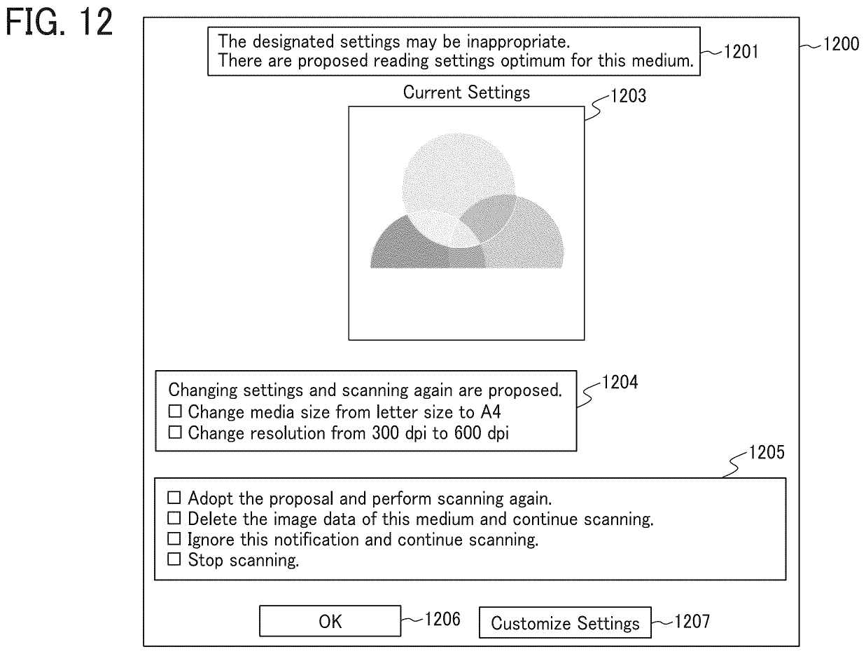

FIG. 12 is a schematic diagram illustrating an example of second display data 1200. As illustrated in FIG. 12, the second display data 1200 includes a summary 1201, a second processed image 1203, a change object 1204, a processing object 1205, an OK button 1206, and a customize button 1207.

The summary 1201 includes the determination result by the determination unit 145, i.e., the message that the setting information designated by the user does not match the features of the input image, and the determination result by the identifying unit 146, i.e., the recommendation of setting information matching the features of the input image. The second processed image 1203 is the second processed image acquired by processing the input image in accordance with the setting information designated by the user.

Similar to the change object 1004, the change object 1204 is an object for changing the setting information designated by the user to the setting information identified by the identifying unit 146 and matching the features of the input image. The change object 1204 includes a button for designating whether to change the setting value designated by the user to the setting value matching the feature information for each setting item determined as having a value mismatched with the features of the input image.

Similar to the processing object 1005, the processing object 1205 is an object for designating post-processing to be executed in the subsequent stage. The processing object 1205 includes a button for designating some kind of post-processing. The post-processing includes re-reading processing, the first continuation processing, the second continuation processing, and the end processing. In other words, the post-processing that can be designated in the processing object 1205 includes the re-reading processing instead of the first change processing and the second change processing. The re-reading processing is the processing of changing the setting information for the input image generated this time and subsequent input images to the setting information designated by the change object 1204. The user can acquire the second processed image (and the processed image) generated according to the appropriate setting information by placing again the medium just conveyed on the medium tray 103 and designating the re-reading processing.

When generating an appropriate processed image from the input image is not feasible, the image reading apparatus 100 requests the user to regenerate the input image so that an appropriate processed image is generated to be compared with the second processed image by the user. Thus, the image reading apparatus 100 can enhance the convenience for the user.

Referring back to FIG. 9, the reception unit 147 stands by until the designation of post-processing is input by the user using the first input device 105 or the information processing apparatus 200, and an instruction signal is received from the first input device 105 or the first communication device 122 (step S115). When the user presses the OK button, the control unit 141 receives the instruction signal instructing the setting information designated by the change object and/or the post-processing designated by the processing object from the first input device 105 or the first communication device 122.

When the reception unit 147 receives the instruction signal, the second setting unit 148 identifies the post-processing instructed by the instruction signal and sets the identified post-processing in the image reading apparatus 100 and/or another image reading apparatus included in the image processing system 1 (step S116).

The second setting unit 148 stores the identified post-processing in the first storage device 130 in association with the combination of the setting information designated by the user and the feature information of the input image generated this time. As a result, when it is determined in future step $108 that the setting information does not match the feature information, the control unit 141 executes the post-processing associated with the combination in step S110. In other words, in the case of the determination that the setting information does not match the feature of the input image, when the reception unit 147 has received the designation of post-processing for the combination of the setting information and the feature of the input image in the past, the control unit 141 executes that post-processing. Even in the case of a mismatch between the setting information and the features of the input image, the image reading apparatus 100 does not repeatedly stop the image reading process for the same combination of the setting information and the features of the input image. Accordingly, an increase of the time for the image reading process can be minimized.

The second setting unit 148 transmits a setting request signal for requesting setting of the identified post-processing in association with the combination of the setting information and the feature information to another image reading apparatus (may be referred to as an “alternate image reading apparatus” in the following description) included in the image processing system 1 via the first communication device 122. The alternate image reading apparatus receiving the setting request signal from the image reading apparatus 100 via the first communication device 122 stores the post-processing designated by the received setting request signal in the first storage device 130 in association with the combination of the setting information and the feature information. As a result, when it is determined in future step

S108 that the setting information does not match the feature information in the future image reading process executed by the alternate image reading apparatus, the control unit 141 executes the post-processing associated with the combination in step S110. In this way, the second setting unit 148 sets the post-processing received by the reception unit 147 as the post-processing for the combination of the setting information and the feature of the input image in the alternate image reading apparatus (image processing apparatus). Even in the case of a mismatch between the setting information and the features of the input image, the image reading apparatus 100 does not stop the image reading process when the post-processing has been designated for that combination in another image reading apparatus. Accordingly, an increase of the time for the image reading process can be minimized.

Note that, when the display data includes a button for instructing not to set the user-designated post-processing in the image reading apparatus 100 and/or another image reading apparatus and the button is pressed, the processing in step S116 may be omitted.

Subsequently, the control unit 141 determines which post-processing is the identified post-processing (step S117).

When the identified post-processing is the first change processing, the generation unit 144 regenerates the second processed image from the input image acquired this time according to the setting information instructed in the instruction signal, and stores the second processed image in the first storage device 130 in association with the media number (step S118). Then, the generation unit 144 proceeds to step S125. In this case, the image reading apparatus 100 regenerates the second processed image based on the input image acquired this time without changing the setting information set in the image reading apparatus 100.

When the identified post-processing is the second change processing, the generation unit 144 reads all the input images generated in the current image reading process, that is, the input images acquired by imaging the respective media collectively placed on the medium tray 103, from the first storage device 130 (step S119).

Subsequently, the generation unit 144 regenerates the second processed images acquired by processing all the read input images according to the setting information instructed in the instruction signal, and stores the second processed image in the first storage device 130 in association with each media number (step S120).

Subsequently, the setting unit 142 sets the setting information instructed in the instruction signal in the first storage device 130, and configures the components such as the imaging device 117 and the motor 121 such that an input image corresponding to the instructed setting information is generated in further (step S121). Then, the setting unit 142 proceeds to step S125.

When the identified post-processing is the first continuation processing, the generation unit 144 deletes the input image and the second processed image generated this time from the first storage device 130 (step S122) and proceeds to step S125.

When the identified post-processing is the second continuation processing, the control unit 141 proceeds to step S125 without executing any particular processing.

When the identified post-processing is the re-reading processing, the setting unit 142 sets the setting information instructed in the instruction signal in the first storage device 130. The setting unit 142 configures the components such as the imaging device 117 and the motor 121 such that an input image corresponding to the instructed setting information is generated in future (step S123).

Subsequently, the control unit 141 drives again the motor 121 to rotate again the feeding roller 112, the separation roller 113, the first conveyance roller 114, the second conveyance roller 115, the third conveyance roller 118, and/or the fourth conveyance roller 119. Thus, the control unit 141 feeds the medium from the medium tray 103 (step S124). Then, the control unit 141 proceeds to step S105. When the identified post-processing is the re-reading processing, the medium just conveyed is placed again on the medium tray 103 by the user. In this case, the image reading apparatus 100 does not output the previously generated second processed image but output the second processed image acquired by processing the input image of the medium placed again.

When the identified post-processing is the end processing, the control unit 141 ends the image reading process.

In this way, when the determination unit 145 determines that the setting information does not match the features of the input image, the reception unit 147 receives the designation of the post-processing from the user. The control unit 141 further executes the post-processing received by the reception unit 147. Thus, the user can take a desired action when the setting information is not appropriate, and the image reading apparatus 100 can take an appropriate action according to an instruction from the user.

The reception unit 147 receives an instruction to change the setting information set by the setting unit 142 to the setting information identified by the identifying unit 146 by receiving the designation of the first change processing, the second change processing, or the re-reading processing as the post-processing. By contrast, the reception unit 147 receives an instruction to change the setting information set by the setting unit 142 to the setting information identified by the identifying unit 146 by receiving the first continuation processing, the second continuation processing, or the end processing as the post-processing. In this way, the reception unit 147 receives an instruction about whether to change the setting information set by the setting unit 142 to the setting information identified by the identifying unit 146. Thus, the user can easily and appropriately change the setting information in accordance with the proposal by the image reading apparatus 100, and the image reading apparatus 100 can increase the convenience for the user.

When the instructed post-processing is the first change processing, the second change processing, the first continuation processing, or the second continuation processing, the control unit 141 drives the motor 121 again. The control unit 141 rotates again the feeding roller 112, the separation roller 113, the first conveyance roller 114, the second conveyance roller 115, the third conveyance roller 118, and/or the fourth conveyance roller 119 to feed the media remaining on the medium tray 103 (step S125).

Subsequently, the control unit 141 outputs the second processed image by transmitting the second processed image to the information processing apparatus 200 via the first communication device 122 (step S126). In a case where the second processed image is deleted in step $122, the control unit 141 does not transmit the second processed image. In a case where the second processed image is not regenerated in step S118 or S120, the control unit 141 transmits the second processed image generated in step S106. in a case where the second processed image is regenerated in step S118 or S122, the control unit transmits the regenerated second processed image. When receiving the second processed image from the image reading apparatus 100 via the second communication device 203, the information processing apparatus 200 stores the second processed image in the second storage device 210. In a case where the instructed post-processing is the second change processing, the generation unit 144 transmits all the second processed images regenerated in step S120 in addition to a replacement request signal for requesting replacement of the second processed images having been output with the regenerated second processed images, respectively. When receiving the replacement request signal from the image reading apparatus 100 via the second communication device 203, the information processing apparatus 200 replaces the second processed images having been received with the newly received second processed images, respectively.

Subsequently, the control unit 141 determines whether a medium remains on the medium tray 103 based on the first media signal received from the first media sensor 111 (step S127). In a case where a medium remains on the medium tray 103, the control unit 141 increments (+1) the media number of the medium to be conveyed, and sets the media number of the media to be conveyed next. Then, the control unit 141 returns the process to step S105 and repeats the process from step $105 to $127.

By contrast, in a case where no medium remains on the medium tray 103, the control unit 141 stops the motor 121 to stop the feeding roller 112, the separation roller 113, the first conveyance roller 114, the second conveyance roller 115, the third conveyance roller 118, and the fourth conveyance roller 119 (step S128). Thus, the control unit 141 stops conveying the media. With this action, the control unit 141 ends the image reading process.

The process of steps S109 to S110, the process of step S116, and/or the process of steps S117 to S124 may be omitted. Further, any of the first change processing, the second change processing, the first continuation processing, the second continuation processing, the re-reading processing, and the end processing may not be included in the post-processing.

As described above in detail, the image reading apparatus 100 determines whether the setting information matches the features of the input image, and generates and displays the processed image acquired by processing the input image in accordance with the setting information matching the features when the setting information does not match the features. The user can determine whether to change the setting information by referring to a preview of the processed image, and the image reading apparatus 100 can increase the convenience for the user.

Further, the image reading apparatus 100 determines whether the setting information matches the features of the input image every time the input image is generated, and immediately outputs the display data when the setting information does not match the features of the input image. Accordingly, the user can immediately take an appropriate action when the setting information is inappropriate. Thus, the image reading apparatus 100 can reduce rework in the user's work and enhance the convenience for the user.

Further, even a user having little knowledge or low skill in the image reading process can appropriately select setting information for generating a desired image. This allows the image reading apparatus 100 to prevent the occurrence of rework in the image reading process due to the use of inappropriate settings and minimize the decrease in the work efficiency or the work quality of the user.

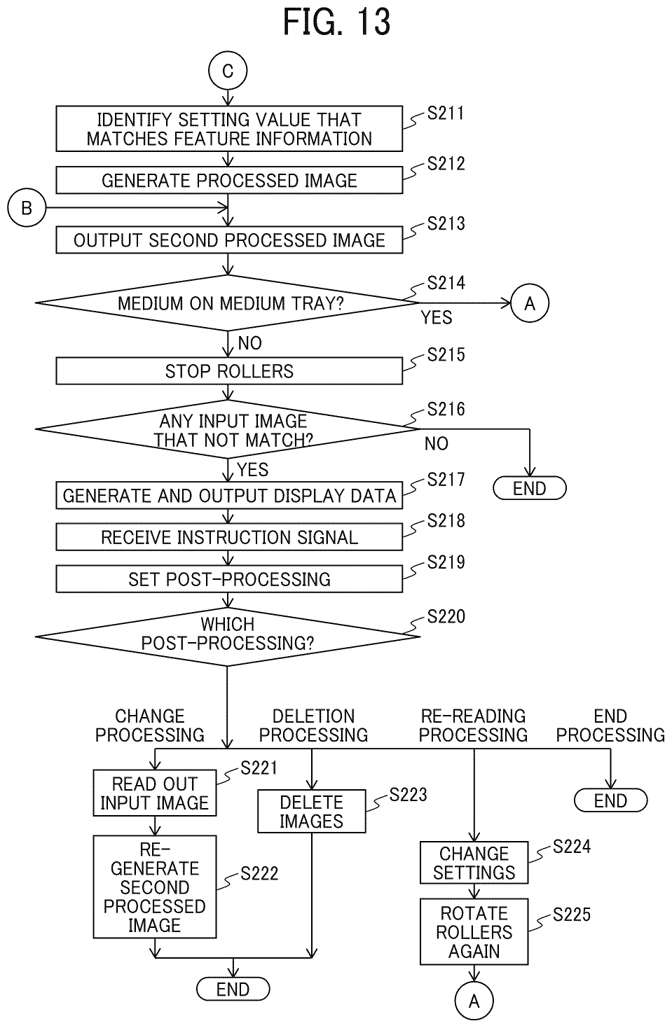

FIG. 13 is a flowchart illustrating a part of an image reading process according to another embodiment.

The process in the flowchart of FIG. 13 is executed instead of the process in the flowchart of FIG. 9. The processes of steps S211 to S212, S214 to S215, and S218 to S219 of FIG. 13 are similar to those of steps S112 to S113, S127 to S128, and S115 to S116 of FIG. 9, respectively, and thus the description thereof will be omitted. In the following, only steps S213, S216 to S217, and S220 to S225 will be described.

In the flowchart illustrated in FIG. 13, as in the flowchart of FIG. 9, the conveyance and imaging of the media are repeated as long as the media remain on the medium tray 103 in step S214. Accordingly, in step S105 of FIG. 8, the acquisition unit 143 acquires multiple input images acquired by capturing respective images of multiple media that are consecutively conveyed. In addition, the process of step S111 of FIG. 9 is omitted, and the control unit 141 does not discontinue the conveyance of the multiple media even in the case of determination that the setting information does not match the features of one or more of the multiple input images.

In step S213, the control unit 141 outputs the second processed image generated in step S106 of FIG. 8 by transmitting the second processed image to the information processing apparatus 200 via the first communication device 122 (step S213).

In step S216, the control unit 141 determines whether there is an input image determined in step S108 of FIG. 8 as having a feature that does not match the user-designated setting information. When there is no input image determined as having a feature that does not match the setting information, the control unit 141 ends the image reading process.

By contrast, when there is an input image determined as having a feature that does not match the setting information, the control unit 141 generates display data for displaying a processed image generated based on the input image determined as having a feature that does not match the setting information. The control unit 141 outputs the generated display data by displaying the second display data on the first display device 106 or transmitting the second display data to the information processing apparatus 200 via the first communication device 122 (step S217). When receiving the display data from the image reading apparatus 100 via the second communication device 203, the information processing apparatus 200 displays the received display data on the second display device 202.

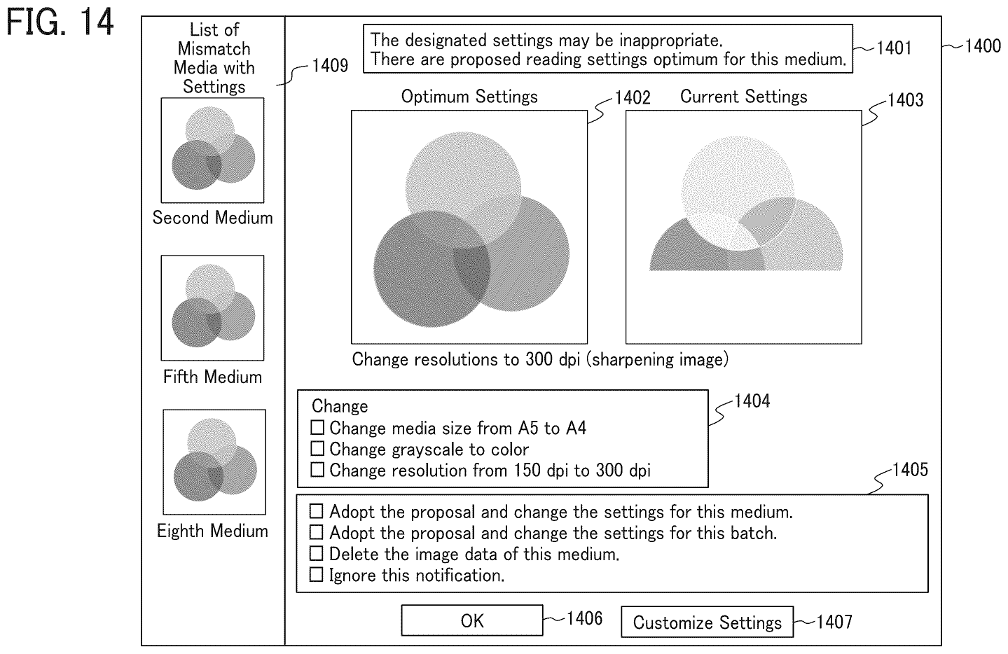

FIG. 14 is a schematic diagram illustrating an example of display data 1400 according to the present embodiment.

As illustrated in FIG. 14, the display data 1400 includes a summary 1401, a processed image 1402, a second processed image 1403, a change object 1404, a processing object 1405, an OK button 1406, a customize button 1407, and a list 1409. In the list 1409, the input images each determined as having a feature that does not match the user-designated setting information, or processed images or second processed images respectively generated based on the input images are displayed in a list selectably by the user. The summary 1401, the processed image 1402, the second processed image 1403, the change object 1404, the processing object 1405, the OK button 1406, and the customize button 1407 are information, objects, or buttons similar to the summary 1001, the processed image 1002, the second processed image 1003, the change object 1004, the processing object 1005, the OK button 1006, and the customize button 1007, respectively.

However, the processed image 1402 and the second processed image 1403 are a processed image and a second processed image corresponding to an image selected by the user in the list 1409, respectively.

The post-processing that can be designated in the processing object 1405 includes re-reading processing, change processing, deletion processing, and ending processing.

The re-reading processing is the processing of changing the setting information to the setting information designated by the change object 1404, and conveying and imaging the medium again. The user can acquire the second processed image generated according to the appropriate setting information by placing again the medium to be conveyed and imaged on the medium tray 103 and designating the re-reading processing.

The change processing is the processing of changing the setting information for all the media having been collectively placed on the medium tray 103 and conveyed to the setting information designated by the change object 1404. The user can acquire the second processed image generated according to the setting information proposed by the image reading apparatus 100 for each of the media collectively placed on the medium tray 103 by designating the change processing. The change processing may be the processing of changing the setting information only for the medium designated by the user to the setting information designated by the change object 1404. In this case, the user can acquire the second processed image generated according to the setting information proposed by the image reading apparatus 100 for the selected medium.

The deletion processing is the processing of deleting the second processed image selected by the user. The user can delete the second processed image generated according to the inappropriate setting information by designating the deletion processing.

The end processing is the processing of ending the image reading process. The user can end the image reading process and re-execute the image reading process in accordance with desired setting information by designating the end processing.

In the display data 1400, the processed image and the second processed image may be displayed in a switchable manner, similarly to the display data 1100. Further, in the display data 1400, the processed image does not have to be displayed, similarly to the second display data 1200.

In this way, when it is determined that the setting information does not match the features of any of the multiple input images, the control unit 141 outputs the display data without discontinuing the conveyance of the multiple media. The image reading apparatus 100 outputs the display data when the conveyance and the imaging of all the media placed on the medium tray 103 are completed, thereby minimizing an increase of the time for the image reading process.

In step S220, the control unit 141 determines which post-processing is the identified post-processing (step S220).

When the identified post-processing is the change processing, the generation unit 144 reads the input images in each of which the medium designated by the instruction signal is imaged from the first storage device 130 (step S221).

Subsequently, the generation unit 144 regenerates the second processed image by processing each read input image according to the setting information instructed in the instruction signal, and outputs the regenerated second processed image by transmitting the regenerated second processed image to the information processing apparatus 200 via the first communication device 122 (step S222). Then, the generation unit 144 ends the image reading process. The generation unit 144 outputs all the regenerated second processed images in addition to a replacement request signal for requesting replacement of the second processed images having been output with the regenerated second processed images, respectively. When receiving the replacement request signal from the image reading apparatus 100 via the second communication device 203, the information processing apparatus 200 replaces the second processed images having been received with the newly received second processed images, respectively.

When the identified post-processing is the deletion processing, the control unit 141 transmits a deletion request signal requesting deletion of the selected second processed image to the information processing apparatus 200 via the first communication device 122 (step S223). Then, the control unit 141 ends the image reading process. When receiving the deletion request signal from the image reading apparatus 100 via the second communication device 203, the information processing apparatus 200 deletes the selected second processed image from the second storage device 210.

When the identified post-processing is the re-reading processing, the setting unit 142 sets the setting information instructed in the instruction signal in the first storage device 130. The setting unit 142 configures the components such as the imaging device 117 and the motor 121 such that an input image corresponding to the instructed setting information is generated in future (step S224).

Subsequently, the control unit 141 drives again the motor 121 to rotate again the feeding roller 112, the separation roller 113, the first conveyance roller 114, the second conveyance roller 115, the third conveyance roller 118, and/or the fourth conveyance roller 119. Thus, the control unit 141 feeds the medium from the medium tray 103 (step S225). Then, the control unit 141 proceeds to step S105. When the identified post-processing is the re-reading processing, the media just conveyed are placed again on the medium tray 103 by the user, and the image reading apparatus 100 again conveys and images the media.

When the identified post-processing is the end processing, the control unit 141 ends the image reading process.

The control unit 141 may generate and output the display data without discontinuing the conveyance of the media each time the processed image is generated in step S212, similarly to the processing in step S114 in FIG. 9. In that case, the control unit 141 generates and outputs the display data 1000 or 1100, or the second display data 1200 every time a processed image is generated. In that case, the display data 1000 or 1100, or the second display data 1200 may include the list 1409 similarly to the display data 1400. In this case, in the list 1409, the input images each determined as having a feature that does not match the setting information are displayed in a manner selectably by the user. When a particular image in the list 1409 is selected by the user, a processed image or a second processed image corresponding to the selected image is displayed in the display data 1000 or 1100, or the second display data 1200. Alternatively, when a particular image in the list 1409 is selected by the user, display data including the processed image or the second processed image corresponding to the selected image may be newly generated and displayed in another window. When the OK button is pressed in the display data 1000 or 1100, or the second display data 1200, the control unit 141 executes the designated post-processing.

As described above in detail, the image reading apparatus 100 can increase the convenience for the user even when outputting the display data without discontinuing the conveyance of the media.

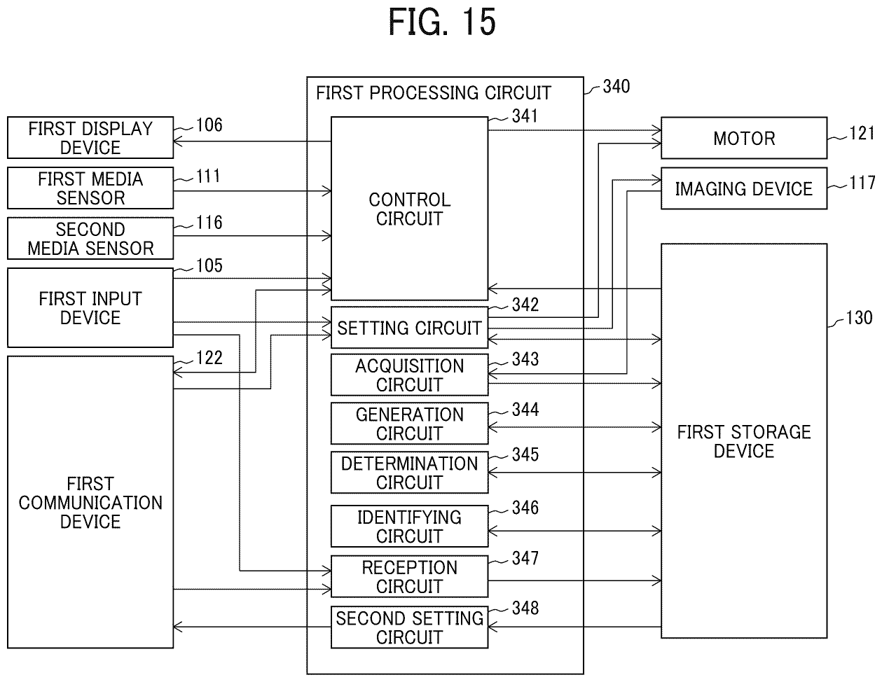

FIG. 15 is a block diagram illustrating a schematic configuration of a first processing circuit 340 of an image reading apparatus according to another embodiment.

The first processing circuit 340 is used in place of the first processing circuit 140 and executes processing such as the image reading process. The first processing circuit 340 includes a control circuit 341, a setting circuit 342, an acquisition circuit 343, a generation circuit 344, a determination circuit 345, an identifying circuit 346, a reception circuit 347, and a second setting circuit 348.

The control circuit 341 is one example of a control unit and functions similarly to the control unit 141. The control circuit 341 receives the operation signal from the first input device 105 or the first communication device 122, the first media signal from the first media sensor 111, and the second media signal from the second media sensor 116. Further, the control circuit 341 reads from the first storage device 130 the determination result indicating whether the user-designated setting information matches the features of the input image. The control circuit 341 controls the motor 121 based on the information received or retrieved. The control circuit 341 further reads from the first storage device 130 the input image, the processed image, the second processed image, the user-designated setting information, and the setting information matching the features of the input image, and generates the display data based on the information thus read. The control circuit 341 outputs the generated display data to the first display device 106 or the first communication device 122. The control circuit 341 reads the post-processing designated by the user from the first storage device 130 and executes the read post-processing.

The setting circuit 342 is one example of a setting unit and functions similarly to the setting unit 142. The setting circuit 342 receives the user-designated setting information from the first input device 105 or the first communication device 122, stores the setting information in the first storage device 130, and sets the setting information in the imaging device 117 or the motor 121. The control circuit 341 reads user-designated setting information from the first storage device 130 and sets the imaging device 117 or the motor 121.

The acquisition circuit 343 is one example of an acquisition unit and functions similarly to the acquisition unit 143. The acquisition circuit 343 acquires an input image from the imaging device 117 and stores the input image in the first storage device 130.

The generation circuit 344 is one example of a generation unit and functions similarly to the generation unit 144. The generation circuit 344 reads from the first storage device 130 the input image, the user-designated setting information, and the setting information matching the features of the input image, generates the processed image and the second processed image based on the information thus read, and stores the processed image and the second processed image in the first storage device 130.

The determination circuit 345 is one example of a determination unit and functions similarly to the determination unit 145. The determination circuit 345 reads the input image and the user-designated setting information from the first storage device 130, determinates whether the setting information matches the features of the input image based on the information thus read, and stores the determination result in the first storage device 130.

The identifying circuit 346 is one example of an identifying unit and functions similarly to the identifying unit 146. The identifying circuit 346 reads the input image from the first storage device 130, identifies the setting information matching the features of the input image, and stores the identified setting information in the first storage device 130.

The reception circuit 347 is one example of a reception unit and functions similarly to the reception unit 147. The reception circuit 347 receives an instruction signal from the first input device 105 or the first communication device 122, and stores the setting information and the post-processing designated by the user in the first storage device 130.

The second setting circuit 348 is one example of a second setting unit and functions similarly to the second setting unit 148. The second setting circuit 348 reads the post-processing designated by the user from the first storage device 130, and transmits a setting request signal to another image reading apparatus via the first communication device 122.

As detailed above, the image reading apparatus using the first processing circuit 340 also increases the convenience for the user.

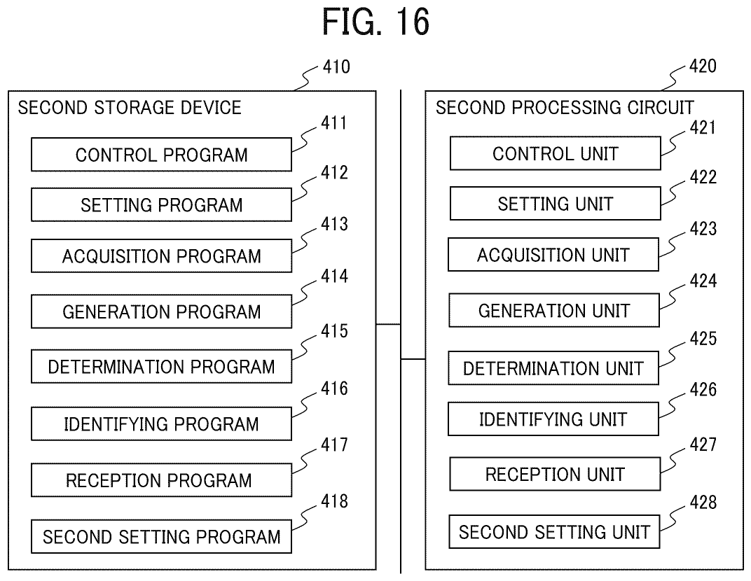

FIG. 16 is a diagram illustrating a schematic configuration of a second storage device 410 and a second processing circuit 420 of an information processing apparatus according to still another embodiment.

As illustrated in FIG. 16, the second storage device 410 stores a control program 411, a setting program 412, an acquisition program 413, a generation program 414, a determination program 415, an identifying program 416, a reception program 417, and a second setting program 418. These programs are functional modules implemented by software operating on a processor. The second processing circuit 420 reads the programs stored in the second storage device 410 and operates according to the read programs, thereby functioning as a control unit 421, a setting unit 422, an acquisition unit 423, a generation unit 424, a determination unit 425, an identifying unit 426, a reception unit 427, and a second setting unit 428.

The control unit 421, the setting unit 422, the acquisition unit 423, the generation unit 424, the determination unit 425, the identifying unit 426, the reception unit 427, and the second setting unit 428 have functions similarly to those of the control unit 141, the setting unit 142, the acquisition unit 143, the generation unit 144, the determination unit 145, the identifying unit 146, the reception unit 147, and the second setting unit 148 of the image reading apparatus 100, respectively. The second storage device 410 stores each data stored by the first storage device 130. The processes of steps S101 to S102, S104 to S122, S201 to S202, and S204 to S214 of the image reading process in FIG. 8 are executed by the control unit 421, the setting unit 422, the acquisition unit 423, the generation unit 424, the determination unit 425, the identifying unit 426, the reception unit 427, and the second setting unit 428.

In steps S101, the control unit 421 stands by until the control unit 421 receives from the second input device 201 an operation signal output in response to the input of an instruction to read media by the user using the second input device 201. The control unit 421 transmits the received operation signal to the image reading apparatus 100 via the second communication device 203.

In step S102, the setting unit 422 acquires the setting information included in the operation signal. In steps S121, S123, and S224, the setting unit 422 acquires the setting information included in the instruction signal. The setting unit 422 sets the acquired setting information in the first storage device 130 and transmits a request signal requesting the generation of an input image according to the acquired setting information to the image reading apparatus 100 via the second communication device 203. The setting unit 142 of the image reading apparatus 100 receives the request signal from the information processing apparatus 200 via the first communication device 122. The setting unit 142 sets the setting information designated by the received request signal in the first storage device 130 and configures the components such as the imaging device 117 and the motor 121 to generate an input image corresponding to the setting information. Thus, the setting unit 422 sets the user-designated setting information.

In steps S104, S124, S125 and S225, the control unit 421 transmits a request signal requesting the driving of the motor 121 to the image reading apparatus 100 via the second communication device 203. The control unit 141 of the image reading apparatus 100 receives the request signal from the information processing apparatus 200 via the first communication device 122 and drives the motor 121 according to the received request signal. Thus, the control unit 421 feeds the media.

In step S105, the acquisition unit 143 transmits the input image to the information processing apparatus 200 via the first communication device 122. The acquisition unit 423 receives the input image from the image reading apparatus 100 via the second communication device 203.

In steps S111, S128, and S215, the control unit 421 transmits a request signal requesting the stop of the motor 121 to the image reading apparatus 100 via the second communication device 203. The control unit 141 of the image reading apparatus 100 receives the request signal from the information processing apparatus 200 via the first communication device 122 and stops the motor 121 according to the received request signal. Thus, the control unit 421 stops conveying the media.

In steps S114 and S217, the control unit 421 outputs the display data by displaying the display data on the second display device 202 or transmitting the display data to another information processing apparatus 200 via the second communication device 203. In steps S115 and S218, the control unit 421 receives the instruction signal from the second input device 201 or from another information processing apparatus 200 via the second communication device 203. In steps S122 and S223, the control unit 421 deletes the input image and the second processed image from the second storage device 210. In steps S126, S213, and S222, control unit 421 outputs the second processed image by displaying the second processed image on the second display device 202.

Some of the processes executed by the units of the information processing apparatus described above may be executed by the corresponding units of the image reading apparatus, respectively.

As detailed above, the image processing system according to the embodiments can increase the convenience for the user also when the information processing apparatus performs a part of the image reading process.

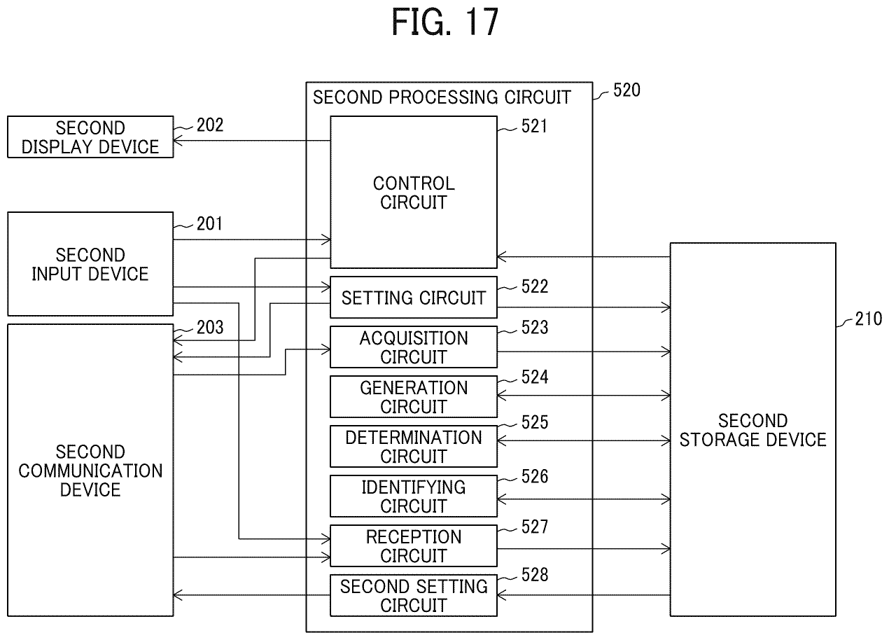

FIG. 17 is a block diagram illustrating a schematic configuration of a second processing circuit 520 of an information processing apparatus according to still another embodiment.

The second processing circuit 520 is used in place of the second processing circuit 420 and executes processes such as the image reading process. The second processing circuit 520 includes a control circuit 521, a setting circuit 522, an acquisition circuit 523, a generation circuit 524, a determination circuit 525, an identifying circuit 526, a reception circuit 527, and a second setting circuit 528.

The control circuit 521 is one example of the control unit and functions similarly to the control unit 421. The control circuit 521 receives an operation signal from the second input device 201 and outputs the received operation signal to the second communication device 203. The control circuit 521 further reads from the second storage device 210 the input image, the processed image, the second processed image, the user-designated setting information, and the setting information matching the features of the input image, and generates the display data based on the information thus read. The control circuit 521 outputs the generated display data to the second display device 202 or the second communication device 203. The control circuit 521 reads the post-processing designated by the user from the second storage device 210 and executes the read post-processing.

The setting circuit 522 is one example of the setting unit and functions similarly to the setting unit 422. The setting circuit 522 receives the user-designated setting information from the second input device 201, stores the setting information in the second storage device 210, and outputs the setting information to the second communication device 203.

The acquisition circuit 523 is one example of the acquisition unit and functions similarly to the acquisition unit 423. The acquisition circuit 523 receives the input image from the second communication device 203 and stores the input image in the second storage device 210.

The generation circuit 524 is one example of the generation unit and functions similarly to the generation unit 424. The generation circuit 524 reads from the second storage device 210 the input image, the user-designated setting information, and the setting information matching the features of the input image, generates the processed image and the second processed image based on the information thus read, and stores the processed image and the second processed image in the second storage device 210.

The determination circuit 525 is one example of the determination unit and functions similarly to the determination unit 425. The determination circuit 525 reads the input image and the user-designated setting information from the second storage device 210, determinates whether the setting information matches the features of the input image based on the information thus read, and stores the determination result in the second storage device 210.

The identifying circuit 526 is one example of the identifying unit and functions similarly to the identifying unit 426. The identifying circuit 526 reads the input image from the second storage device 210, identifies the setting information matching the features of the input image, and stores the identified setting information in the second storage device 210.

The reception circuit 527 is one example of the reception unit and functions similarly to the reception unit 427. The reception circuit 527 receives an instruction signal from the second input device 201 or the second communication device 203, and stores the setting information and the post-processing designated by the user in the second storage device 210.

The second setting circuit 528 is one example of the second setting unit and functions similarly to the second setting unit 428. The second setting circuit 528 reads the post-processing designated by the user from the second storage device 210, and transmits a setting request signal to another image reading apparatus via the second communication device 203.

As detailed above, the information processing apparatus using the second processing circuit 520 also increases the convenience for the user.

Although the preferred embodiments have been described above, the embodiments are not limited thereto. For example, the image reading apparatus may have a so-called U-turn path, feed the media placed on the medium tray sequentially from the top, and discharge the media to the ejection tray.

In one aspect, a control program for controlling a computer includes a plurality of program codes which, when executed by the computer, causes the computer to perform a method including: setting first setting information designated by a user regarding an input image generation process; acquiring an input image in which a medium is imaged according to the first setting information; determining, based on the input image, whether the first setting information matches a feature of the input image; identifying second setting information matching the feature of the input image in a case of determining that the first setting information does not match the feature of the input image; processing the input image according to the second setting information to generate a processed image when processing the input image according to the second setting information is feasible; and outputting display data for displaying the processed image on a display.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), and/or combinations thereof which are configured or programmed, using one or more programs stored in one or more memories to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. An image processing apparatus comprising
circuitry configured to:
set first setting information regarding an input image generation process;
acquire an input image in which a medium is imaged according to the first setting information;
determine, based on the input image, whether the first setting information matches a feature of the input image;
identify second setting information matching the feature of the input image when determining that the first setting information does not match the feature of the input image;
process the input image according to the second setting information to generate a processed image when processing the input image according to the second setting information is feasible; and
output display data for displaying the processed image on a display.

2. The image processing apparatus according to claim 1,
wherein the circuitry is further configured to receive an instruction indicating whether to change the first setting information to the second setting information.

3. The image processing apparatus according to claim 1,
wherein, when processing the input image according to the second setting information is not feasible, the circuitry is configured to output another display data for requesting generation of another input image to be processed according to the second setting information.

4. The image processing apparatus according to claim 1,
wherein the circuitry is configured to:
process the input image according to the first setting information to generate a second processed image; and
generate the display data such that the processed image and the second processed image are displayed adjacent to each other.

5. The image processing apparatus according to claim 1,
wherein the processed image generated by processing the input image according to the second setting information is referred to as a first processed image, and
wherein the circuitry is configured to:
process the input image according to the first setting information to generate a second processed image; and
generate the display data such that the first processed image and the second processed image are displayed in place of each other.

6. The image processing apparatus according to claim 1,
wherein the first setting information includes a setting value for each of multiple items, and
wherein the circuitry is configured to:
determine whether the setting value matches the feature of the input image for each of the multiple items,
identify a setting value matching the feature of the input image for each item determined as having a mismatched setting value with the feature of the input image, and
process the input image according to the identified setting value for each item determined as having the mismatched setting value.

7. The image processing apparatus according to claim 1,
wherein the circuitry is further configured to:
receive designation of post-processing when determining that the first setting information does not match the feature of the input image;
execute the post-processing that is designated; and
when determining that the first setting information does not match the feature of the input image, execute post-processing that is designated in the past for a combination of the first setting information and the feature of the input image.

8. The image processing apparatus according to claim 1,
wherein the circuitry is configured to:
acquire multiple input images by capturing respective images of multiple media that are consecutively conveyed; and
output the display data without discontinuing conveyance of the multiple media when determining that the first setting information does not match a feature of one or more of the multiple input images.

9. The image processing apparatus according to claim 1,
wherein the circuitry is further configured to:
receive designation of post-processing when determining that the first setting information does not match the feature of the input image;
execute the post-processing that is designated; and
set, in another image processing apparatus, the post-processing that is designated as post-processing corresponding to a combination of the first setting information and the feature of the input image.

10. An image processing system including an image reading apparatus and an information processing apparatus, the image processing system comprising
circuitry configured to:
acquire first setting information regarding an input image generation process;
acquire an input image in which a medium is imaged according to the first setting information;
determine, based on the input image, whether the first setting information matches a feature of the input image;
identify second setting information matching the feature of the input image when determining that the first setting information does not match the feature of the input image;
process the input image according to the second setting information to generate a processed image when processing the input image according to the second setting information is feasible; and
display the processed image on a display.

11. An image processing method comprising:
setting first setting information regarding an input image generation process;
acquiring an input image in which a medium is imaged according to the first setting information;
determining, based on the input image, whether the first setting information matches a feature of the input image;
identifying second setting information matching the feature of the input image based when determining that the first setting information does not match the feature of the input image;
processing the input image according to the second setting information to generate a processed image when processing the input image according to the second setting information is feasible; and
outputting display data for displaying the processed image on a display.
